(19) United States
(12) Patent Application Publication
(10) Pub. No.: US 2017/0297559 A1
(43) Pub. Date: Oct. 19, 2017

(54) Hybrid Vehicle and Control Method For Hybrid Vehicle

(71) Applicant: TOYOTA JIDOSHA KABUSHIKI KAISHA, Toyota-shi (JP)

(72) Inventors: Koki MINAMIKAWA, Nagoya-shi (JP); Masayuki BABA, Toyota-shi (JP); Munehiro KATSUMATA, Toyota-shi (JP)

(73) Assignee: TOYOTA JIDOSHA KABUSHIKI KAISHA, Toyota-shi (JP)

(21) Appl. No.: 15/483,268

(22) Filed: Apr. 10, 2017

(30) Foreign Application Priority Data
Apr. 19, 2016 (JP) 2016-084068

(51) Int. Cl. B60W 20/30; B60K 6/543; B60W 10/105; F16H 3/72; F16H 61/02; F16H 61/66; B60K 6/44; B60K 6/365

(52) U.S. Cl. CPC B60W 20/30; B60K 6/44; B60K 6/543; B60W 10/105; B60K 6/365; F16H 3/728; F16H 61/0204; F16H 61/66; F16H 2061/6615; F16H 2061/6603; B60Y 2200/92; F16H 2200/0043; F16H 2200/201; F16H 2200/2041; F16H 2200/2066; F16H 2200/2082; Y10S 903/911; Y10S 903/945; Y10S 903/918

(57) ABSTRACT

A plurality of virtual gear positions are established by an electric continuously variable transmission, and the number of speeds of the virtual gear positions is equal to or larger than the number of speeds of mechanical gear positions of a mechanical stepwise variable transmission. One or two or more virtual gear positions is/are assigned to each mechanical gear position, and shifts among the mechanical gear positions are performed in the same timing as the shift timing of the virtual gear positions. Thus, shifting of the mechanical stepwise variable transmission is accompanied by change of the engine speed Ne, and the driver is less likely to feel uncomfortable even if shift shock occurs during shifting of the mechanical stepwise variable transmission.

### INCORPORATION BY REFERENCE

The disclosure of Japanese Patent Application No. 2016-084068 filed on Apr. 19, 2016 including the specification, drawings and abstract is incorporated herein by reference in its entirety.

### BACKGROUND

### 1. Technical Field

The disclosure relates to a hybrid vehicle, and a control method for the hybrid vehicle. In particular, the disclosure is concerned with a hybrid vehicle including an electric continuously variable transmission and a mechanical stepwise variable transmission that are arranged in series.

### 2. Description of Related Art

A vehicle is known which has an electric continuously variable speed change unit that can steplessly change the rotational speed of a drive source through torque control of a differential rotating machine, and transmit resulting rotation to an intermediate transmission member, and a mechanical stepwise variable speed change unit that is disposed between the intermediate transmission member and drive wheels, and can mechanically establish a plurality of gear positions having different speed ratios of the rotational speed of the intermediate transmission member to the output rotational speed. A hybrid vehicle described in Japanese Patent Application Publication No. 2006-321392 (JP 2006-321392 A) is one example of this type of vehicle. According to a technology described in JP 2006-32192 A, in order to curb occurrence of shift shock due to change of the rotational speed in the inertia phase, during shifting of the mechanical stepwise variable speed change unit, the speed ratio of the electric continuously variable speed change unit is changed while the rotational speed of the drive source is kept substantially constant, so as to start the inertia phase of the mechanical stepwise variable speed change unit.

### SUMMARY

However, it is difficult to completely prevent shift shock even in the shift control system as described above, and even a slight shock may cause the driver to feel strange or uncomfortable since the rotational speed of the drive source is substantially constant.

This disclosure is to further reduce the feeling of strangeness of the driver caused by shift shock during shifting of a mechanical stepwise variable transmission, in a vehicle having an electric continuously variable transmission and the mechanical stepwise variable transmission.

A first aspect of the disclosure is a hybrid vehicle. The hybrid vehicle includes an electric continuously variable transmission, a mechanical stepwise variable transmission, and an electronic control unit. The electric continuously variable transmission is configured to steplessly change a rotational speed of a drive source through torque control of a differential rotating machine, and transmit resulting rotation to an intermediate transmission member. The mechanical stepwise variable transmission is disposed between the intermediate transmission member and drive wheels. The mechanical stepwise variable transmission is configured to establish a plurality of mechanical gear positions having different speed ratios of a rotational speed of the intermediate transmission member to an output rotational speed of the mechanical stepwise variable transmission. The mechanical gear positions are mechanically established by the mechanical stepwise variable transmission. The electronic control unit is configured to control the electric continuously variable transmission so as to establish a plurality of virtual gear positions having different speed ratios of the rotational speed of the drive source to the output rotational speed of the mechanical stepwise variable transmission. The number of speeds of the plurality of virtual gear positions is equal to or larger than the number of speeds of the plurality of mechanical gear positions, and at least one of the virtual gear positions is assigned to each of the mechanical gear positions. The electronic control unit is configured to control the electric continuously variable transmission so as to shift the electric continuously variable transmission from one of the virtual gear positions to another according to predetermined shift conditions. Shift conditions of the plurality of mechanical gear positions being determined such that the mechanical stepwise variable transmission is shifted from one of the mechanical gear positions to another in the same timing as shift timing of the virtual gear positions.

In the hybrid vehicle, the electronic control unit may be configured to limit a shift range of the virtual gear positions, such that a specified virtual gear position is set to an upper limit of the shift range, when any of the mechanical gear positions of the mechanical stepwise variable transmission is not established. The specified virtual gear position is a virtual gear position assigned to one of the mechanical gear positions which is lower by one speed than the mechanical gear position that is not established.

A second aspect of the disclosure is a control method for a hybrid vehicle. The hybrid vehicle includes an electric continuously variable transmission, a mechanical continuously variable transmission, and an electronic control unit. The electric continuously variable transmission is configured to steplessly change a rotational speed of a drive source through torque control of a differential rotating machine, and transmit resulting rotation to an intermediate transmission member. The mechanical stepwise variable transmission is disposed between the intermediate transmission member and drive wheels. The mechanical stepwise variable transmission is configured to establish a plurality of mechanical gear positions having different speed ratios of a rotational speed of the intermediate transmission member to an output rotational speed of the mechanical stepwise variable transmission. The mechanical gear positions are mechanically established by the mechanical stepwise variable transmission. The control method includes controlling, by the electronic control unit, the electric continuously variable transmission so as to establish a plurality of virtual gear positions having different speed ratios of the rotational speed of the drive source to the output rotational speed of the mechanical stepwise variable transmission. The number of speeds of the plurality of virtual gear positions is equal to or larger than the number of speeds of the plurality of mechanical gear positions, and at least one of the virtual gear positions is assigned to each of the mechanical gear positions. The control method further includes controlling, by the electronic control unit, the electric continuously variable transmission so as to shift the electric continuously variable transmission from one of the virtual gear positions to another according to predetermined shift conditions. Shift conditions of the plurality of mechanical gear positions being determined such that the mechanical stepwise variable transmission is shifted from one of the mechanical gear positions to another in the same timing as shift timing of the virtual gear positions.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a view showing a vehicle to which this disclosure is applied, along with a principal part of a control system;

FIG. 2 is a view useful for explaining the relationship between a plurality of gear positions of a mechanical stepwise variable transmission of FIG. 1, and hydraulic friction devices that establish the gear positions;

FIG. 3 is a circuit diagram showing a hydraulic control circuit associated with clutches C1, C2 and brakes B1, B2 of the mechanical stepwise variable transmission of FIG. 1;

FIG. 4 is a view useful for explaining one example of a plurality of virtual gear positions when the speed ratio of the electric continuously variable transmission of FIG. 1 is changed stepwise;

FIG. 5 is a view useful for explaining one example of a virtual gear position shift map used when the virtual gear positions of FIG. 4 are shifted or switched from one to another;

FIG. 6 is a view useful for explaining one example of a gear position assignment table in which the virtual gear positions of FIG. 4 are assigned to the mechanical gear positions of FIG. 2;

FIG. 7 is a view showing 4th speed to 6th speed of virtual gear positions established when the mechanical gear position is a 2nd-speed position in FIG. 6, on a nomographic chart;

FIG. 8 is a flowchart illustrating operation for changing assignment of the gear positions when any of the mechanical gear positions cannot be established by the mechanical stepwise variable transmission; and

FIG. 9 is a flowchart executed in place of that of FIG. 8, according to another embodiment of the disclosure.

### DETAILED DESCRIPTION OF EMBODIMENTS

Next, the configuration of this disclosure will be described.

As a drive source of a hybrid vehicle, an engine, such as an internal combustion engine that generates power by burning fuel, an electric motor, or the like, is favorably used. While an electric continuously variable transmission has a differential mechanism, such as a planetary gear unit, it may use a paired-rotor electric motor having an inner rotor and an outer rotor. When the paired-rotor motor is used as the electric continuously variable transmission, the drive source is connected to one of the inner rotor and the outer rotor, and an intermediate transmission member is connected to the other rotor. Like a motor-generator, the paired-rotor motor can selectively deliver power running torque and regenerative torque, and also functions as a rotating machine for differential operation (which will be called “differential rotating machine”). The drive source and the intermediate transmission member are connected to the differential mechanism, or the like, via a clutch or a speed change gear, as needed. A rotating machine for driving the vehicle for traveling (which will be called “driving rotating machine”) is connected to the intermediate transmission member directly or via a speed change gear, or the like, as needed.

As the differential mechanism of the electric continuously variable transmission, a single planetary gear unit of a single pinion type or double pinion type is favorably used. The planetary gear unit includes three rotating elements, i.e., a sun gear, a carrier, and a ring gear. In a nomographic chart in which respective rotational speeds of the three rotating elements can be connected by a single straight line, the drive source is connected to a rotating element (the carrier of the single pinion type planetary gear unit, or the ring gear of the double pinion type planetary gear unit) located at the middle in the chart and having a middle rotational speed, and the differential rotating machine and the intermediate transmission member are connected to the rotating elements at the opposite ends in the chart, for example. The intermediate transmission member may be connected to the middle rotating element, and the differential rotating machine and the drive source may be connected to the rotating elements at the opposite ends. While the three rotating elements may be differentially rotatable at all times, any two of the rotating elements may be integrally connected by a clutch, such that they can rotate as a unit according to operating conditions. Also, differential rotation of the three rotating elements may be restricted by stopping rotation of the rotating element to which the differential rotating machine is connected, by means of a brake. Further, a differential mechanism as a combination of two or more planetary gear units may be employed as the electric continuously variable transmission.

The rotating machine, which means a rotating electric machine, is specifically an electric motor, a generator, or a motor-generator that can selectively use the functions of the motor and the generator. Motor-generators may be used as both the differential rotating machine, and the driving rotating machine. A generator may be employed as the differential rotating machine, and an electric motor may be employed as the driving rotating machine.

As a mechanical stepwise variable transmission, a transmission of a planetary gear type or parallel shaft type is widely used. In the transmission, two or more hydraulic friction devices are engaged and released, for example, so that a plurality of gear positions (mechanical gear positions) can be established. While the mechanical gear positions appropriately provide forward gear positions, they may provide backward gear positions.

The electric continuously variable transmission and the mechanical stepwise variable transmission are controlled by an electronic control unit, so that a plurality of virtual gear positions can be established. The virtual gear positions are established by controlling the rotational speed of the drive source according to the output rotational speed such that the speed ratio of each gear position can be maintained. The speed ratio of each of the virtual gear positions need not be a constant value like those of the mechanical gear positions of the mechanical stepwise variable transmission, but may be changed within a given range. Further, the speed ratio of each virtual gear position may be limited by the upper limit or lower limit of the rotational speed of each part, for example. For example, shift conditions of the virtual gear positions may be defined by using a shift map of upshift lines and downshift lines determined in advance based on operating conditions of the vehicle, such as the output rotational speed and the accelerator operation amount, as parameters. In this connection, automatic shift conditions other than the shift map may be set as the shift conditions of the virtual gear positions, or the virtual gear position may be changed or shifted according to a shift command of the driver, by use of a shift lever or an UP/DOWN switch, for example. While it is desirable that this disclosure is applied to both upshifts and downshifts, it may only be applied to either of upshifts and downshifts. Namely, virtual stepwise shifts using the virtual gear positions may be performed as one of the upshifts and the downshifts, and stepless speed changes similar to conventional ones may be performed as the other.

The number of speeds of the virtual gear positions may be equal to or larger than the number of speeds of the mechanical gear positions. While the number of speeds of the virtual gear positions may be equal to that of the mechanical gear positions, it is desirable that the number of speeds of the virtual gear positions is larger than that of the mechanical gear positions, and it is appropriately equal to or larger than twice the number of speeds of the mechanical gear positions. Shifts of the mechanical gear positions are performed such that the rotational speed of the intermediate transmission member or the driving rotating machine connected to the intermediate transmission member is held within a given rotational speed range. Meanwhile, shifts of the virtual gear positions are performed such that the rotational speed of the drive source is held within a given rotational speed range. Accordingly, while the number of speeds of the mechanical gear positions and the number of speeds of the virtual gear positions are determined as appropriate, the number of speeds of the mechanical gear positions is appropriately within the range of about two speeds to six speeds, for example, while the number of speeds of the virtual gear positions is appropriately within the range of five speeds to twelve speeds, for example.

When any of the mechanical gear positions cannot be established, the electronic control unit limits the shift range of the virtual gear positions, such that the virtual gear position assigned to the mechanical gear position that is lower by one speed than the mechanical gear position that cannot be established is set to the upper limit. However, the electronic control unit may include the virtual gear position(s) assigned to the mechanical gear position that cannot be established, within the shift permissible range, as long as the rotational speed of the intermediate transmission member or the driving rotating machine does not become excessively high. Namely, shift control may be performed using all of the virtual gear positions, irrespective of restriction of the mechanical gear positions. In this case, when the mechanical gear position that has been unable to be established due to a low oil temperature, for example, becomes able to be established due to increase of the oil pressure, shock and uncomfortable feeling given to the driver can be further reduced when the electronic control unit returns to normal shift control, including that of the mechanical stepwise variable transmission. When any of the mechanical gear positions cannot be established due to a failure of a solenoid valve for shifting, virtual stepwise shifts using the virtual gear positions may be inhibited and switched to stepless speed change. When the virtual stepwise shifts are inhibited and switched to the stepless speed change, the rotational speed of the drive source is less likely or unlikely to be restricted, as compared with the virtual stepwise shifts; therefore, power performance needed for limp-home traveling can be appropriately ensured. Thus, it may be determined whether the virtual stepwise shifts are continued or switched to stepless speed change, depending on the cause of the failure to establish the mechanical gear position.

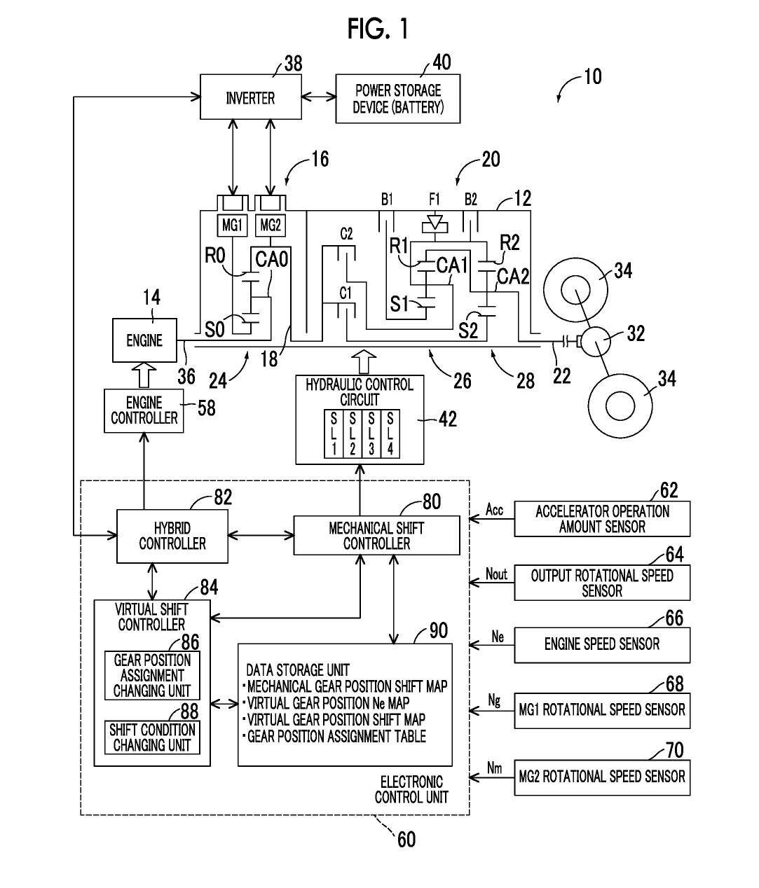

One embodiment of the disclosure will be described in detail with reference to the drawings. FIG. 1 is a skeleton diagram of a vehicular drive system 10 to which this disclosure is applied, which also shows a principal part of a control system in connection with shift control. The vehicular drive system 10 includes an engine 14, an electric continuously variable transmission 16, a mechanical stepwise variable transmission 20, and an output shaft 22, which are arranged in series and disposed on a common axis within a transmission case 12 (which will be called “case 12”) as a non-rotating member mounted on the vehicle body. The electric continuously variable transmission 16 is connected to the engine 14 directly or indirectly via a damper (not shown), or the like. The mechanical stepwise variable transmission 20 is connected to the output side of the electric continuously variable transmission 16. The output shaft 22 is connected to the output side of the mechanical stepwise variable transmission 20. In operation, the drive force of the engine 14 is transmitted from the output shaft 22 to a pair of drive wheels 34, via a differential gear unit (final reduction gear) 32, a pair of axles, etc. The vehicular drive system 10 is favorably used in a FR (front-engine, rear-drive) vehicle in which the system 10 is longitudinally mounted, for example. The engine 14 is a drive source for running the vehicle, and is an internal combustion engine, such as a gasoline engine or a diesel engine. In this embodiment, the engine 14 is connected to the electric continuously variable transmission 16 with no hydraulic transmission device, such as a torque converter or a fluid coupling, interposed therebetween.

The electric continuously variable transmission 16 includes a first motor-generator MG1 for differential operation, a differential mechanism 24, and a second motor-generator MG2 for running or driving the vehicle. The differential mechanism 24 is configured to mechanically distribute the output or power of the engine 14 to the first motor-generator MG1 and the intermediate transmission member 18. The second motor-generator MG2 is operatively connected to the intermediate transmission member 18 so as to rotate as a unit with the member 18. Each of the first motor-generator MG1 and the second motor-generator MG2 can be selectively used as an electric motor or a generator. The first motor-generator MG1 corresponds to the differential rotating machine, and the second motor-generator MG2 corresponds to the driving rotating machine. The vehicular drive system 10 of this embodiment is concerned with a hybrid vehicle including the engine 14 and the second motor-generator MG2 as drive sources for running the vehicle.

The differential mechanism 24 is in the form of a single pinion type planetary gear unit, and includes a sun gear S0, a carrier CA0, and a ring gear R0. The carrier CA0 is a first rotating element connected to the engine 14 via a connecting shaft 36. The sun gear S0 is a second rotating element connected to the first motor-generator MG1. The ring gear R0 is a third rotating element connected to the intermediate transmission member 18. In other words, in a nomographic chart of the electric continuously variable transmission 16 shown on the left side in FIG. 7, the engine (E/G) 14 is connected to the carrier CA0 that is located at the middle in the chart and provides the middle rotational speed, and the first motor-generator MG1 for differential operation, and the second motor-generator MG2 for running/driving the vehicle are connected to the sun gear S0 and the ring gear R0 which are located at the opposite ends. The sun gear S0, carrier CA0, and the ring gear R0 can rotate relative to each other. The output of the engine 14 is divided and distributed to the first motor-generator MG1 and the intermediate transmission member 18, so that regeneration control (which is also called “power generation control”) is performed on the first motor-generator MG1. The second motor-generator MG2 is rotated/driven with electric energy obtained through the regeneration control of the first motor-generator MG1, or a power storage device (battery) 40 is charged with the electric energy via an inverter 38. Thus, the differential status of the differential mechanism 24 can be changed as needed, by controlling the rotational speed (MG1 rotational speed) Ng of the first motor-generator MG1, through regeneration control or power running control of the first motor-generator MG1. Namely, the differential status of the differential mechanism 24 can be changed as needed, by controlling the rotational speed of the sun gear S0. Accordingly, the differential mechanism 24 can steplessly (continuously) change the speed ratio γ1 (=Ne/Nm) of the rotational speed of the connecting shaft 36 or the rotational speed (engine speed) Ne of the engine 14, to the rotational speed (intermediate transmission member rotational speed) Nm of the intermediate transmission member 18. Since the intermediate transmission member rotational speed Nm is equal to the rotational speed (MG2 rotational speed) of the second motor-generator MG2, these speeds will be denoted by the same symbol Nm.

The mechanical stepwise variable transmission 20 provides a part of a power transmission path between the engine 14 and the drive wheels 34, and is a planetary gear type, multiple-speed transmission having a single pinion type first planetary gear unit 26 and a single pinion type second planetary gear unit 28. The first planetary gear unit 26 includes a sun gear 51, a carrier CA1, and a ring gear R1. The second planetary gear unit 28 includes a sun gear S2, a carrier CA2, and a ring gear R2. The sun gear 51 is selectively connected to the case 12 via a first brake B1. The sun gear S2 is selectively connected to the intermediate transmission member 18 via a first clutch C1. The carrier CA1 and the ring gear R2 are connected integrally with each other, and are selectively connected to the intermediate transmission member 18 via a second clutch C2. The carrier CA1 and the ring gear R2 are selectively connected to the case 12 via a second brake B2. The carrier CA1 and the ring gear R2 are connected to the case 12 as a non-rotating member via a one-way clutch F1, so as to be allowed to rotate in the same direction as the engine 14 but inhibited from rotating in the reverse direction. The ring gear R1 and the carrier CA2 are connected integrally with each other, and are connected integrally to the output shaft 22.

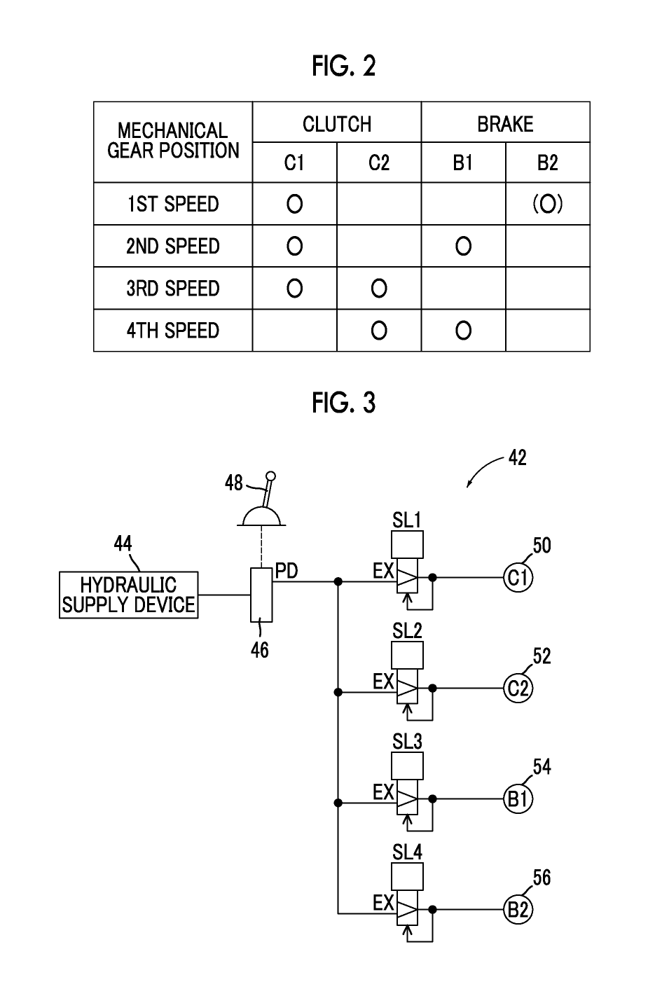

With the clutches C1, C2 and the brakes B1, B2 (which will be simply referred to as “clutches C” and “brakes B” when they are not particularly distinguished) selectively engaged, the mechanical stepwise variable transmission 20 is placed in a selected one of a plurality of forward gear positions having different speed ratios γ2 (=Nm/Nout) of the intermediate transmission member rotational speed Nm to the rotational speed (output rotational speed) Nout of the output shaft 22. The forward gear positions correspond to the mechanical gear positions that are mechanically established. As shown in the engaging operation table of FIG. 2, the mechanical 1st-speed gear position having the largest speed ratio γ2 is established when the first clutch C1 and the second brake B2 are engaged. Also, the mechanical 2nd-speed gear position having a smaller speed ratio γ2 than that of the mechanical 1st-speed gear position is established when the first clutch C1 and the first brake B1 are engaged. Further, the mechanical 3rd-speed gear position of which the speed ratio γ2 is equal to 1 is established when the first clutch C1 and the second clutch C2 are engaged. Then, the 4th-speed gear position of which the speed ratio γ2 is smaller than 1 is established when the second clutch C2 and the first brake B1 are engaged. Since the one-way clutch F1 is provided in parallel with the second brake B2, the second brake B2 may be engaged in the mechanical 1st-speed gear position when an engine brake is applied in a driven mode, and may be held in a released state in a driving mode, such as when the vehicle is started.

The clutches and the brakes B are multi-plate or single-plate type hydraulic friction devices that are frictionally engaged by hydraulic pressure. FIG. 3 is a circuit diagram showing a principal part of a hydraulic control circuit 42 including linear solenoid valves SL1-SL4 that control engagement and release of the clutches C and the brakes B. In the hydraulic control circuit 42, a D range pressure (forward range pressure) PD is supplied from a hydraulic supply device 44 via a manual valve 46. The hydraulic supply device 44 includes a mechanical oil pump, an electric oil pump, or the like, as a hydraulic pressure source, and delivers a given hydraulic pressure (line pressure) regulated by a line-pressure control valve, or the like. The mechanical oil pump is a pump rotated or driven by the engine 14. The electric oil pump is a pump driven by an electric motor when the engine is not in operation. The manual valve 46 is operable to mechanically or electrically switch oil passages according to operation of a shift lever 48. The manual valve 46 delivers the D range pressure PD when the shift lever 48 is operated to select a D range for forward traveling. The shift lever 48 is operable to select the D range for forward traveling, R range for reverse traveling, or N range for cutting off power transmission, for example.

Linear solenoid valves SL1-SL4 as hydraulic control devices are provided for respective hydraulic actuators (hydraulic cylinders) 50, 52, 54, 56 of the clutches C1, C2 and the brakes B1, B2. The linear solenoid valves SL1-SL4 are independently energized and de-energized by the electronic control unit 60. With the hydraulic pressures of the respective hydraulic actuators 50, 52, 54, 56 thus independently regulated and controlled, engagement and release of the clutches C1, C2 and the brakes B1, B2 are individually controlled, so that the mechanical 1st-speed gear position through the mechanical 4th-speed gear position are established. Also, in shift control of the mechanical stepwise variable transmission 20, clutch-to-clutch shift is performed. The clutch-to-clutch shift is shift control under which release and engagement of selected ones of the clutches C and brakes B which are associated with the shift are controlled at the same time. For example, on a 3→2 downshift from the mechanical 3rd-speed gear position to the mechanical 2nd-speed gear position, the second clutch C2 is released, and the first brake B1 is engaged at the same time, as indicated in the engaging operation table of FIG. 2. In order to suppress or reduce shift shock, the transient hydraulic pressure for releasing the second clutch C2 and the transient hydraulic pressure for engaging the second brake B2 are regulated or controlled according to predetermined change patterns, for example. Thus, the hydraulic pressures, or engagement torques, of the engagement devices (clutches C, brakes B) of the mechanical stepwise variable transmission 20 can be independently and continuously controlled by the linear solenoid valves SL1-SL4, respectively.

The vehicular drive system 10 includes an electronic control unit 60 as a controller that performs output control of the engine 14, and shift control of the electric continuously variable transmission 16 and the mechanical stepwise variable transmission 20. The electronic control unit 60 includes a microcomputer having CPU, ROM, RAM, input/output interface, and so forth. The electronic control unit 60 performs signal processing according to programs stored in advance in the ROM, while utilizing the temporary storage function of the RAM. The electronic control unit 60 may include two or more electronic control units for use in engine control, shift control, etc. as needed. The electronic control unit 60 receives various kinds of information needed for control, such as the amount of operation of the accelerator pedal (accelerator operation amount) Acc, output rotational speed Nout, engine speed Ne, MG1 rotational speed Ng, and the MG2 rotational speed Nm, from an accelerator operation amount sensor 62, output rotational speed sensor 64, engine speed sensor 66, MG1 rotational speed sensor 68, MG2 rotational speed sensor 70, and so forth. The output rotational speed Nout corresponds to the vehicle speed V.

The electronic control unit 60 functionally includes a mechanical shift controller 80, a hybrid controller 82, and a virtual shift controller 84. The mechanical shift controller 80 makes a shift determination for the mechanical stepwise variable transmission 20, according a predetermined mechanical gear position shift map, using the output rotational speed Nout and the accelerator operation amount Acc as parameters, and changes engaged/released states of the clutches C and the brakes B as needed by means of the linear solenoid valves SL1-SL4, so as to automatically change the mechanical gear position of the mechanical stepwise variable transmission 20. The mechanical gear position shift map is determined such that the MG2 rotational speed Nm as the rotational speed of the intermediate transmission member 18 and the second motor-generator MG2 is held within a given rotational speed range. The mechanical gear position shift map is stored in advance in a data storage unit 90.

The hybrid controller 82 operates the engine 14 in an operating range having a high fuel efficiency, and performs stepless shift control for steplessly changing the speed ratio γ1 of the electric continuously variable transmission 16. The stepless shift control is performed by controlling the proportion of driving force between the engine 14 and the second motor-generator MG2 and reaction force produced through power generation of the first motor-generator MG1, so as to steplessly change the speed ratio γ1 of the electric continuously variable transmission 16. For example, the hybrid controller 82 calculates a target (required) output of the vehicle from the accelerator operation amount Acc as the driver-requested output amount and the vehicle speed V, when the vehicle is travelling at the vehicle speed V, and calculates a necessary total target output from the target output of the vehicle and a charge required value. Then, the hybrid controller 82 obtains necessary input torque Tin of the mechanical stepwise variable transmission 20, according to the speed ratio γ2 of the mechanical gear position of the mechanical stepwise variable transmission 20, so that the total target output is obtained. Further, the hybrid controller 82 calculates a target engine output (required engine output) with which the necessary input torque Tin is obtained, in view of assist torque of the second motor-generator MG2, etc. Then, the hybrid controller 82 controls the engine 14 and controls the amount of power generation (regenerative torque) of the first motor-generator MG1 in a feedback manner, so as to achieve the engine speed Ne and engine torque Te with which the target engine output is obtained. The hybrid controller 82 performs the output control of the engine 14, via an engine controller 58 including an electronic throttle valve that controls the intake air amount, fuel injection device that controls the fuel injection amount, ignition device of which the ignition timing can be controlled to be advanced or retarded, and so forth. Also, the hybrid controller 82 performs power running control and regeneration control of the first motor-generator MG1 and the second motor-generator MG2, while performing charge/discharge control of the power storage device 40 via the inverter 38.

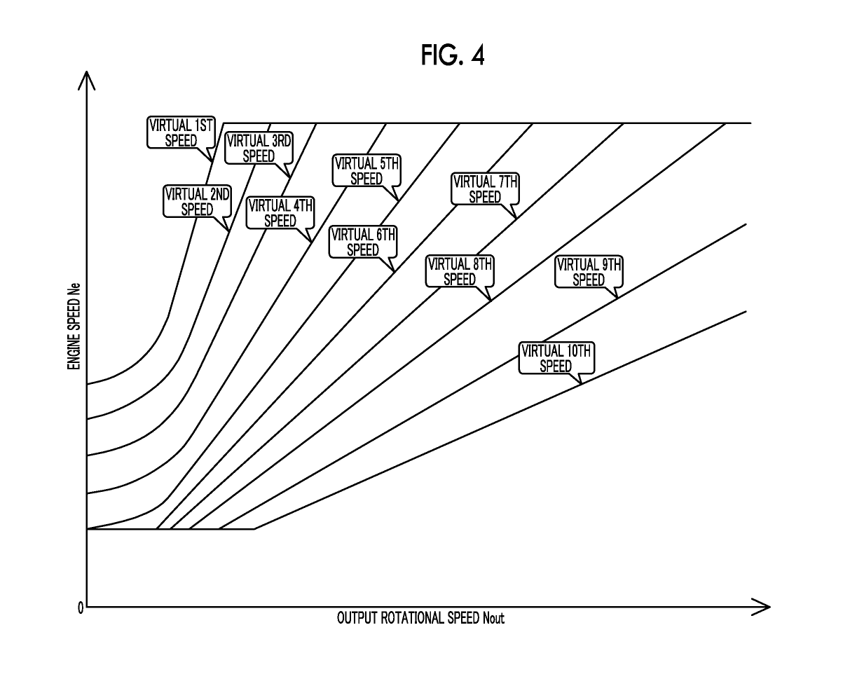

The virtual shift controller 84 controls the electric continuously variable transmission 16 so as to establish a plurality of virtual gear positions having different speed ratios γ0 (=Ne/Nout) of the engine speed Ne to the output rotational speed Nout of the mechanical stepwise variable transmission 20. The virtual shift controller 84 performs shift control according to a predetermined virtual gear position shift map, so as to establish the virtual gear positions. The speed ratio γ0 is a value (γ0=γ1×γ2) obtained by multiplying the speed ratio γ1 of the electric continuously variable transmission 16 by the speed ratio γ2 of the mechanical stepwise variable transmission 20. As shown in FIG. 4 by way of example, the virtual gear positions can be established by controlling the engine speed Ne by means of the first motor-generator MG1, according to the output rotational speed Nout, so that the speed ratio γ0 of each gear position can be maintained. The speed ratio γ0 of each virtual gear position need not be a constant value (a straight line that passes the origin 0 in FIG. 4), but may be changed in a given range, or may be limited by the upper limit and/or lower limit of the rotational speed of each part, for example. FIG. 4 shows the case where 10-speed shifts involving virtual 1st-speed gear position through virtual 10th-speed gear position as the plurality of virtual gear positions can be performed. As is apparent from FIG. 4, a selected one of the virtual gear positions can be established merely by controlling the engine speed Ne according to the output rotational speed Nout, irrespective of the type of the mechanical gear position of the mechanical stepwise variable transmission 20.

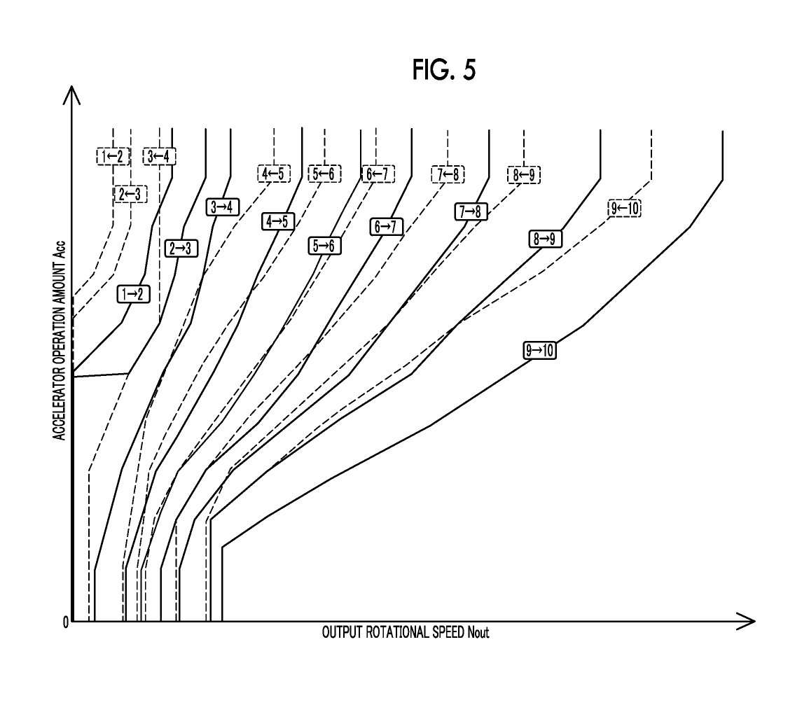

Like the mechanical gear position shift map, the virtual gear position shift map used for switching the virtual gear positions is determined in advance, using the output rotational speed Nout and the accelerator operation amount Acc as parameters. FIG. 5 is one example of the virtual gear position shift map, in which solid lines are upshift lines, and broken lines are downshift lines, while the engine speed Ne is held in a given rotational speed range. The virtual gear position shift map corresponds to virtual gear position shift conditions. Thus, the engine speed Ne is changed stepwise if the virtual gear positions are switched according to the virtual gear position shift map; therefore, the vehicle of this embodiment as a whole provides substantially the same shift feeling as that provided by the mechanical stepwise variable transmission. The virtual stepwise shifts may be performed in priority to stepless shift control executed by the hybrid controller 82, only when the driver selects a traveling mode, such as a sporty traveling mode, which emphasizes the traveling performance, for example. However, in this embodiment, the virtual stepwise shifts are basically performed except for the time when a certain restriction is placed on their implementation. The virtual gear position shift map of FIG. 5 and the engine speed map of each virtual gear position in FIG. 4 are stored in advance in the data storage unit 90.

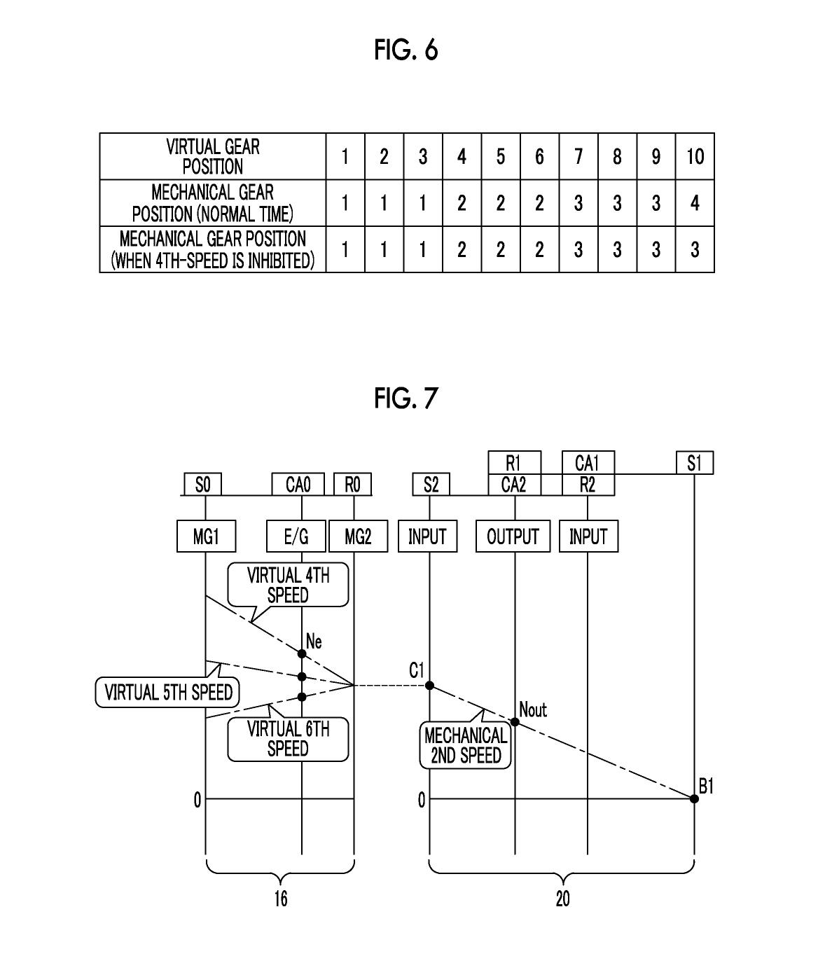

Here, the virtual stepwise shift control performed by the virtual shift controller 84 and the mechanical stepwise shift control performed by the mechanical shift controller 80 are controlled in coordination. Namely, the number of speeds of the virtual gear positions is 10 speeds, which is larger by four speeds than the number of speeds of the mechanical gear positions, and one virtual gear position or two or more virtual gear positions are assigned to each mechanical gear position, so that the virtual gear position(s) is/are established while the mechanical gear position is established. FIG. 6 is one example of a gear position assignment table, in which the virtual gear positions are determined such that, during normal operation, the virtual 1st-speed gear position to the virtual 3rd-speed gear position are established with respect to the mechanical 1st-speed gear position, and the virtual 4th-speed gear position to the virtual 6th-speed gear position are established with respect to the mechanical 2nd-speed gear position. Further, the virtual gear positions are determined such that, during normal operation, the virtual 7th-speed gear position to the virtual 9th-speed gear position are established with respect to the mechanical 3rd-speed gear position, and the virtual 10th-speed gear position is established with respect to the mechanical 4th-speed gear position. Also, under the virtual stepwise shift control by the virtual shift controller 84, when the mechanical 4th-speed gear position is inhibited (becomes unable to be established) under a certain condition, such as a low oil temperature, a gear position assignment table for use at the time when the mechanical 4th-speed is inhibited is prepared, in which the virtual 10th-speed gear position is assigned to the mechanical 3rd-speed gear position. These gear position assignment tables are also stored in advance in the data storage unit 90. FIG. 7 is one example of a nomographic chart in which rotational speeds of respective parts of the electric continuously variable transmission 16 and the mechanical stepwise variable transmission 20 can be connected by straight lines. FIG. 7 illustrates the case where the virtual 4th-speed gear position to the virtual 6th-speed gear position are established, when the mechanical gear position of the mechanical stepwise variable transmission 20 is the 2nd speed (mechanical 2nd speed). In the case of FIG. 7, each virtual gear position is established, by controlling the engine speed Ne so as to provide a given speed ratio γ0 with respect to the output rotational speed Nout.

With the above arrangement in which the plurality of virtual gear positions are assigned to the plurality of mechanical gear positions, a 1⇄2 shift of the mechanical gear position is performed when a 3⇄4 shift of the virtual gear position is performed, and a 2⇄3 shift of the mechanical gear position is performed when a 6⇄7 shift of the virtual gear position is performed, while a 3⇄4 shift of the mechanical gear position is performed when a 9⇄10 shift of the virtual gear position is performed. In this case, the mechanical gear position shift map is determined such that shifts of the mechanical gear positions are performed in the same timing as shift timing of the virtual gear positions. More specifically, the upshift lines “3→4”, “6→7”, and “9→10” in FIG. 5 respectively coincide with the upshift lines “1→2”, “2→3”, and “3→4” of the mechanical gear position shift map. Further, the downshift lines “3←4”, “6←7”, “9←10” in FIG. 5 respectively coincide with the downshift lines “1←2”, “2←3”, “3←4” of the mechanical gear position shift map. A shift command of the mechanical gear positions may be generated to the mechanical shift controller 80, based on a shift determination made on the virtual gear positions according to the virtual gear position shift map of FIG. 5. Thus, since the mechanical gear positions are switched in the same timing as the shift timing of the virtual gear positions, shifting of the mechanical stepwise variable transmission 20 is accompanied by change of the engine speed Ne. Therefore, even if shift shock occurs during shifting of the mechanical stepwise variable transmission 20, the driver is less likely or unlikely to feel strange or uncomfortable.

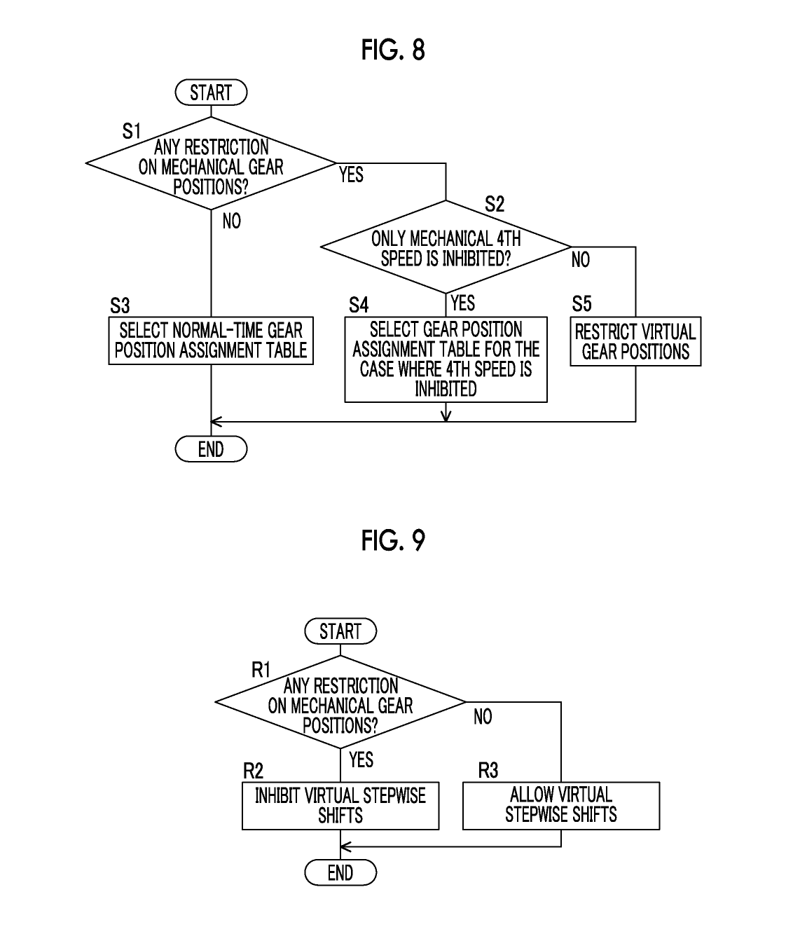

The virtual shift controller 84 functionally includes a gear position assignment changing unit 86 in connection with assignment of the gear positions. The gear position assignment changing unit 86 changes assignment of the gear positions when there is a restriction on establishment of a part of the mechanical gear positions. The gear position assignment changing unit 86 performs signal processing according to steps S1-S5 of the flowchart of FIG. 8. In step S1 of FIG. 8, it is determined whether there is any restriction on establishment of the mechanical gear position(s). The establishment of the mechanical gear position(s) is restricted, for example, in the case where the working oil of the hydraulic control circuit 42 has a low oil temperature, or because of a failure, such as disconnection of any solenoid of the linear solenoid valves SL1-SL4. Therefore, in step S1, it is determined whether any mechanical gear position is inhibited from being established, under the fail-safe function, or the like. If there is no restriction on the mechanical gear positions, step S3 is executed, and the normal gear position assignment table of FIG. 6 is selected. If any of the mechanical gear positions is restricted, step S2 is executed.

In step S2, it is determined whether only the mechanical 4th-speed gear position is inhibited. If only the mechanical 4th-speed gear position is inhibited, step S4 is executed. As one example of the case where only the mechanical 4th-speed gear position is inhibited, a clutch-to-clutch shift to the mechanical 4th-speed gear position having the smallest speed ratio γ2 is inhibited when the oil pressure is low, for example. In step S4, the gear position assignment table of FIG. 6 for the case where the mechanical 4th-speed gear position is inhibited is selected. Namely, shifts up to the virtual 10th-speed gear position are permitted while the mechanical 3rd-speed gear position is maintained. In this case, when the mechanical 4th-speed gear position, which has been inhibited from being established due to the low oil temperature, becomes able to be established due to increase of the oil pressure, for example, it is possible to return to normal control only by shifting up the mechanical stepwise variable transmission 20 to the mechanical 4th-speed gear position. Therefore, the control is easy, and shock and the feeling of strangeness given to the driver can be reduced.

If a negative decision (NO) is made in the above step S2, namely, any of the mechanical 1st-speed gear position to the mechanical 3rd-speed gear position is inhibited, the virtual gear positions are restricted in step S5. In step S5, the shift range of the virtual gear positions is limited, such that the virtual gear position assigned to the mechanical gear position that is lower by one speed than the inhibited mechanical gear position, in the normal-time gear position assignment table of FIG. 6, is set to the upper limit. More specifically, when the mechanical 3rd-speed gear position is inhibited, the virtual 6th-speed gear position as the highest-speed position of those assigned to the mechanical 2nd-speed gear position is set to the upper limit, and shift control is performed within the range of the virtual 1st-speed gear position to the virtual 6th-speed gear position. When the mechanical 2nd-speed gear position is inhibited, the virtual 3rd-speed gear position as the highest-speed position of those assigned to the mechanical 1st-speed gear position is set to the upper limit, and shift control is performed within the range of the virtual 1st-speed gear position to the virtual 3rd-speed gear position. Thus, if the virtual gear positions on the higher speed side are restricted, the vehicle speed V is restricted with increase of the engine speed Ne, and excessive increase of the MG2 rotational speed Nm corresponding to the input rotational speed of the mechanical stepwise variable transmission 20 is prevented. Accordingly, reduction of the durability of the second motor-generator MG2 due to the excessively high MG2 rotational speed Nm is avoided, for example. The above step S5 corresponds to the virtual gear position restricting unit.

When the mechanical 4th-speed gear position is inhibited, too, the virtual 9th-speed gear position as the highest-speed position of those assigned to the mechanical 3rd-speed gear position that is lower by one speed than the mechanical 4th-speed gear position may be set to the upper limit, and shift control may be performed within the range of the virtual 1st-speed gear position to the virtual 9th-speed gear position, as in the case where the mechanical 2nd-speed gear position or the mechanical 3rd-speed gear position is inhibited. Also, when the mechanical 1st-speed gear position is inhibited, namely, when the first clutch C1 cannot be engaged, the virtual stepwise shift control is inhibited, for example, and the hybrid controller 82 performs stepless shift control on the electric continuously variable transmission 16. With regard to the mechanical stepwise variable transmission 20, the mechanical 4th-speed gear position, in which the first clutch C1 need not be engaged, is established. In the meantime, when any of the mechanical 1st-speed gear position to the mechanical 3rd-speed gear position cannot be used, because of a low oil temperature, or for other temporary reasons, all of the virtual gear positions up to the virtual 10th-speed gear position may be assigned to the mechanical gear positions that can be used, as the upper limit, and the electric continuously variable transmission 16 and all of the virtual gear positions may be used for shifting. In this case, control is easy when returning to normal control under which shift control is performed using all of the mechanical gear positions, due to increase of the oil temperature, for example, and shock and the feeling of strangeness given to the driver can be reduced.

Referring back to FIG. 1, the virtual shift controller 84 also functionally includes a shift condition changing unit 88. When the driver selects one of two or more types of traveling modes and switches to the selected traveling mode, or the traveling mode is automatically switched to the one selected according to vehicle conditions, the shift condition changing unit 88 changes shift conditions according to the selected traveling mode, namely, changes the virtual gear position shift map shown in FIG. 5. The two or more types of traveling modes from which one is selected by the driver include an economical/ecological traveling mode that places emphasis on the fuel efficiency, and a sporty traveling mode that places emphasis on the traveling performance, for example. The above-mentioned vehicle conditions include the presence of toeing, road surface gradient, outside temperature, working oil temperature, and the driver's preference in driving, for example. While the virtual gear position shift map may be changed by switching from one of predetermined shift maps separately prepared for the respective traveling modes, to another map, the normal-time shift map shown in FIG. 5 may be corrected. In this case, the mechanical gear position shift map of the mechanical stepwise variable transmission 20 is also changed, and the mechanical gear position is shifted or changed in the same timing as the shift timing of the virtual gear position, irrespective of the type of the traveling mode.

Thus, in the vehicular drive system 10 of this embodiment, the electric continuously variable transmission 16 is placed in a selected one of a plurality of virtual gear positions having different speed ratios γ0 of the engine speed Ne to the output rotational speed Nout, and the electric continuously variable transmission 16 is shifted up or down according to the predetermined virtual gear position shift map. Therefore, the engine speed Ne is changed stepwise at the time of shifting, and the same or similar shift feeling as that provided by the mechanical stepwise variable transmission is obtained. In this case, the number (10 in this embodiment) of speeds of the virtual gear positions of the electric continuously variable transmission 16 is equal to or larger than the number (4 in this embodiment) of speeds of the mechanical gear positions of the mechanical stepwise variable transmission 20. The vertical gear positions are assigned to the mechanical gear positions such that one virtual gear position or two or more virtual gear positions is/are established with respect to each mechanical gear position. Further, on a shift to a particular virtual gear position, such as a shift from the virtual 3rd-speed gear position to the virtual 4th-speed gear position, a shift of the mechanical gear position is performed in the same timing as the shift timing of the virtual gear position. Thus, shifting of the mechanical stepwise variable transmission 20 is accompanied by change of the engine speed Ne, and the driver is less likely or unlikely to feel strange or uncomfortable even if shift shock occurs during shifting of the mechanical stepwise variable transmission 20.

Also, when the mechanical 2nd-speed gear position or mechanical 3rd-speed gear position of the mechanical stepwise variable transmission 20 cannot be established due to a failure, or the like, the shift range of the virtual gear positions is limited, such that the highest-speed position of the virtual gear positions assigned to the mechanical gear position that is lower by one speed than the mechanical gear position that cannot be established is set to the upper limit; therefore, the vehicle speed V is restricted with increase of the engine speed Ne. Therefore, the MG2 rotational speed Nm corresponding to the input rotational speed of the mechanical stepwise variable transmission 20 is prevented from excessively increasing.

In the above embodiment, when there is a restriction on establishment of the mechanical gear positions, the gear position assignment table for use in the case where the mechanical 4th-speed position is inhibited is used according to the flowchart of FIG. 8 (S4), or the shift range of the virtual gear positions is restricted (S5). However, virtual stepwise shifts may be simply inhibited as shown in FIG. 9 by way of example. Namely, it is determined in step R1 whether there is a restriction on establishment of any of the mechanical gear positions. If there is no restriction, virtual stepwise shifts are allowed to be carried out in step R3. If there is a restriction, virtual stepwise shifts are inhibited in step R2, and the hybrid controller 82 performs stepless shift control on the electric continuously variable transmission 16. Under the stepless shift control, the engine speed Ne can be controlled irrespective of the vehicle speed V; thus, since there is no restriction on the engine speed Ne, in contrast to virtual stepwise shifts, the power performance needed for limp-home traveling can be appropriately ensured.

While some embodiments of the disclosure have been described in detail with reference to the drawings, these are mere examples of implementation, and this disclosure may be embodied with various changes or improvements, based on the knowledge of those skilled in the art.

What is claimed is:

1. A hybrid vehicle comprising:
an electric continuously variable transmission configured to steplessly change a rotational speed of a drive source through torque control of a differential rotating machine, and transmit resulting rotation to an intermediate transmission member;
a mechanical stepwise variable transmission disposed between the intermediate transmission member and drive wheels, the mechanical stepwise variable transmission being configured to establish a plurality of mechanical gear positions having different speed ratios of a rotational speed of the intermediate transmission member to an output rotational speed of the mechanical stepwise variable transmission, the mechanical gear positions being mechanically established by the mechanical stepwise variable transmission; and
an electronic control unit configured to control the electric continuously variable transmission so as to establish a plurality of virtual gear positions having different speed ratios of the rotational speed of the drive source to the output rotational speed of the mechanical stepwise variable transmission, the number of speeds of the plurality of virtual gear positions being equal to or larger than the number of speeds of the plurality of mechanical gear positions, at least one of the virtual gear positions being assigned to each of the mechanical gear positions,
the electronic control unit being configured to control the electric continuously variable transmission so as to shift the electric continuously variable transmission from one of the virtual gear positions to another according to predetermined shift conditions, shift conditions of the plurality of mechanical gear positions being determined such that the mechanical stepwise variable transmission is shifted from one of the mechanical gear positions to another in the same timing as shift timing of the virtual gear positions.

2. The hybrid vehicle according to claim 1, wherein
the electronic control unit is configured to limit a shift range of the virtual gear positions, such that a specified virtual gear position is set to an upper limit of the shift range, when any of the mechanical gear positions of the mechanical stepwise variable transmission is not established, the specified virtual gear position is a virtual gear position assigned to a specified mechanical gear position, the specified mechanical gear position is lower by one speed than the mechanical gear position that is not established.

3. A control method for a hybrid vehicle, the hybrid vehicle including
an electric continuously variable transmission configured to steplessly change a rotational speed of a drive source through torque control of a differential rotating machine, and transmit resulting rotation to an intermediate transmission member,
a mechanical stepwise variable transmission disposed between the intermediate transmission member and drive wheels, the mechanical stepwise variable transmission being configured to establish a plurality of mechanical gear positions having different speed ratios of a rotational speed of the intermediate transmission member to an output rotational speed of the mechanical stepwise variable transmission, the mechanical gear positions being mechanically established by the mechanical stepwise variable transmission, and
an electronic control unit,
the control method comprising:
controlling, by the electronic control unit, the electric continuously variable transmission so as to establish a plurality of virtual gear positions having different speed ratios of the rotational speed of the drive source to the output rotational speed of the mechanical stepwise variable transmission, the number of speeds of the plurality of virtual gear positions being equal to or larger than the number of speeds of the plurality of mechanical gear positions, at least one of the virtual gear positions being assigned to each of the mechanical gear positions; and
controlling, by the electronic control unit, the electric continuously variable transmission so as to shift the electric continuously variable transmission from one of the virtual gear positions to another according to predetermined shift conditions, shift conditions of the plurality of mechanical gear positions being determined such that the mechanical stepwise variable transmission is shifted from one of the mechanical gear positions to another in the same timing as shift timing of the virtual gear positions.

4. The control method according to claim 3, wherein
a shift range of the virtual gear positions is limited by the electronic control unit, such that a specified virtual gear position is set to an upper limit of the shift range, when any of the mechanical gear positions of the mechanical stepwise variable transmission is not established, the specified virtual gear position being a virtual gear position assigned to a specified mechanical gear position, the specified mechanical gear position is lower by one speed than the mechanical gear position that is not established.
